(19) United States
(12) Patent Application Publication
(10) Pub. No.: US 2014/0288987 A1
(43) Pub. Date: Sep. 25, 2014

(54) SYSTEM AND METHOD FOR MANAGING PROJECT, PROCESS, AND MEETING TASKS OVER A NETWORK

(71) Applicant: Godwin Liu, Toronto (CA)

(72) Inventor: Godwin Liu, Toronto (CA)

(21) Appl. No.: 14/354,727

(22) PCT Filed: Oct. 26, 2012
(86) PCT No.: PCT/CA2012/000993

§ 371 Date: Apr. 28, 2014

Related U.S. Application Data
(60) Provisional application No. 61/551,686, filed on Oct. 26, 2011.

(51) Int. Cl. G06Q 10/06

(52) U.S. Cl. CPC G06Q 10/063114
USPC 705/7.15

(57) ABSTRACT

The present specification provides a system and method for improving task productivity for multiple people by enhancing task workflow communication amongst team members across a network creating a task owner account from which at least one single task is created with shared responsibility and shared work within a team of participants each having a respective accounts; assigning participant responsibilities within said team for said shared work; and managing task execution via said task owner account.

### FIELD

The present specification relates generally to computing devices and more specifically relates to a system and method for improving worker productivity and effectiveness by automatically facilitating electronic communication relating to tasks that require shared responsibility of multiple people.

### BACKGROUND

Although systems exist to help people individually manage their own tasks and “to do” lists, complex projects and processes require input from teams of people (often from different organizations) working together on tasks with shared responsibility. Although methodologies for managing tasks with shared responsibility exist, none have been implemented in network-based client-server systems for allowing multiple users to collaboratively execute and manage these tasks, their priorities, and their time allocations. In particular, the modern form of matrixed organization with multiple reporting lines complicates the execution of tasks and is a frequent source of problems in ensuring task completion, thereby hindering the progress of processes, projects, and the effective follow-through of meetings. In addition to complications relating to matrixed organizations, projects often span organizations. A single system that allows individuals to manage their tasks in the context of their shared responsibilities is helpful in such situations.

### BRIEF DESCRIPTION OF THE DRAWINGS

FIG. 1 is a schematic representation of a system for improving worker productivity, according to an embodiment.

FIG. 2 is a flow chart depicting a method for a task owner represented by an account on the system of FIG. 1, to manage the execution of a single task that has shared responsibility, according to an embodiment.

FIG. 3 is a flow chart depicting a pair of additional instances of the method according to FIG. 2, for additional task participants represented by respective accounts on the system of FIG. 1 to manage respective responsibilities relating to the single task of FIG. 2, according to an embodiment.

FIG. 4 is a graphic representation of how multiple responsibilities can be allocated using the system and method set forth herein.

FIG. 5 shows an example screen that can be generated on the display shown in FIG. 1, which shows example contents of an project owner account.

FIG. 6 shows an example screen that can be generated on the display shown in FIG. 1, which shows example contents of an process owner account.

FIG. 7 shows the example screen of FIG. 6 with a pop up menu containing options that can be selected in relation to a particular selected task.

### DETAILED DESCRIPTION OF THE EMBODIMENTS

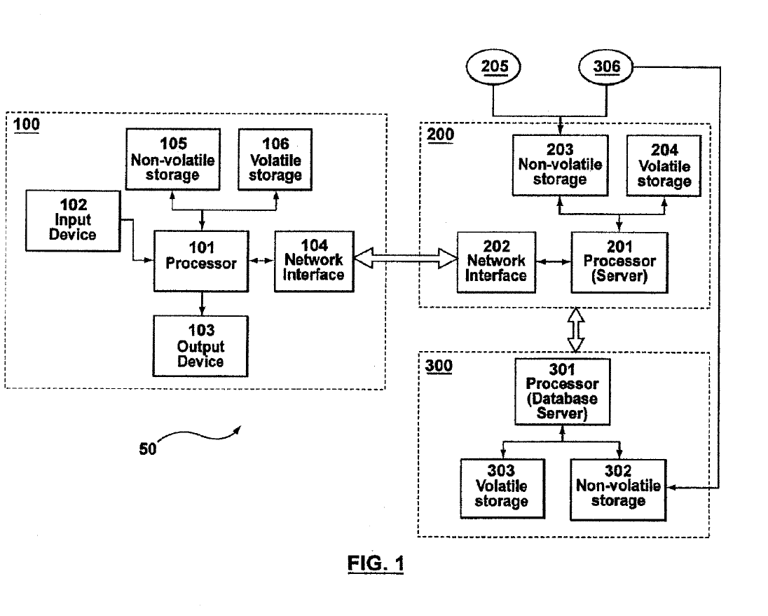

Referring now to FIG. 1, a system for collecting and interacting with task information is indicated generally at 50. System 50 comprises at least one machine 100 that can be based on any known or future network-capable computer system, including a network-capable mobile device. Machine 100 (client computer) comprises at least one processor 101 that can be based on any known or future contemplated central processing units. Processor 101 is connected to at least one input device 102 which in a present embodiment is implemented as a keyboard, but in other embodiments can comprise a touch screen. Other types of input devices are contemplated. Processor 101 is thus configured to receive operational instructional input via input device 102. Processor 101 is also connected to at least one output device 103, which in a present embodiment is implemented as a display screen, but in other embodiments can comprise a speaker. Other types of output devices are contemplated. A combination of a plurality of different types of input devices 102 and/or output devices 103 is also contemplated and can be incorporated into variations of machine 100. Network interface device 104 is a combined input/output device implemented as a communication port or a wireless transceiver.

System 50 also comprises at least one machine 200 that can be based on any known or future network capable computer system, including a cloud-based cluster computing system. Machine 200 (server computer) comprises at least one processor 201 that can be based on any known or future contemplated central processing units. Network interface device 202 is a combined input/output device implemented as a communication port or a wireless transceiver.

System 50 may also include a further machine 300 that can be based on any known or future network capable computer system, including a cluster of computer systems. Machine 300 (database server) comprises at least one processor 301 that can be based on any known or future contemplated central processing unit. The function of machine 300, which will be discussed below, may also be served by machine 200, if no machine 300 is configured separately. Machine 300 communicates with machine 200, for example via a network interface (not shown).

Machines 100, 200 and 300 also include non-transitory electronic storage, implemented in a present embodiment as non-volatile storage 105, 203, and 302 and volatile storage 106, 204, and 303. Non-volatile storage 105, 203, and 302 can be implemented as erasable programmable memory, while volatile storage 106, 204 and 303 can be implemented as random access memory. Other ways of implementing non-transitory storage media will now occur to those skilled in the art.

Non-volatile storage 203, which is a type of non-transitory computer readable medium, is configured to store programming instructions 205 which are executable on processor 201 utilizing volatile storage 204 as needed. Non-volatile storage 203 is also configured to store shared responsibility task information in a task database 306, that are received and recorded using one or more instances of machine 100, over a network.

It is to be understood that the configuration shown for system 50 in FIG. 1 is exemplary, and that other hardware configurations are contemplated. Also, it is contemplated that the functionality of machines 100, 200 and 300 may be implemented in software. Such alternative of hardware and software configurations for system 50 will now occur to those skilled in the art.

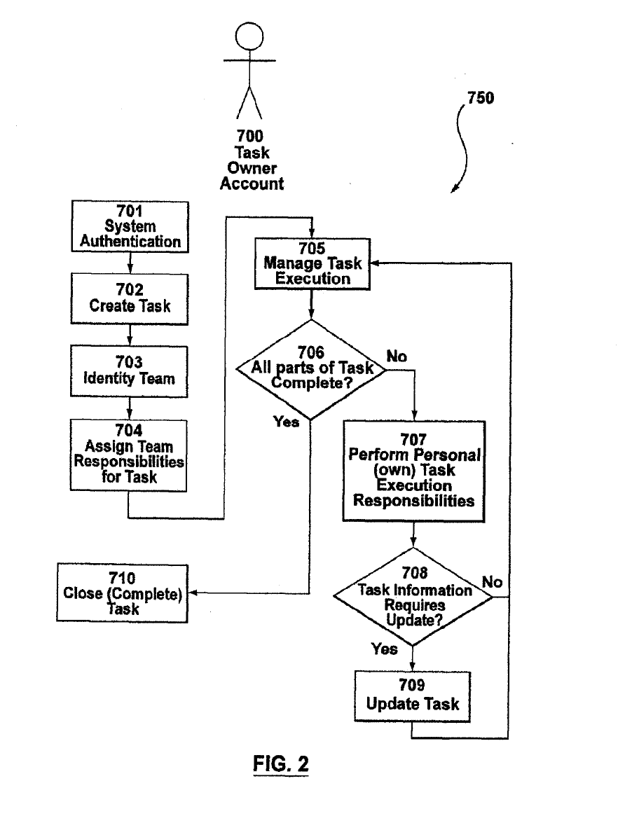

Referring now to FIG. 2, a method 750 depicts the overall transfer of data to assist in the management of a workflow for a task by the task's owner having an account 700 on the system 50, wherein the workflow relates to a single task with shared responsibility and shared work within a team. The task owner account 700 is associated with a specific individual responsible for managing the workflow and completion of the shared task and the work of one or more people. A person of skill in the art will now understand that an account such as account 700 can be implemented as a directory object stored at machine 200 (e.g. in non-volatile storage 203) that is automatically assigned a security ID (SID), which can be used to access domain resources such as machines 100, 200 and 300. The directory object contains, as a minimum, a user name and some kind of authentication token, such as a password. The directory object may also contain additional information about an account such as a primary contact email address, an organization identifier, and/or an identifier to link to an external authentication system. Thus, an account can be used to authenticate the identity of the task owner and authorize or deny access to domain resources, even if the owners belong to different organizations, with the system 50 dynamically authorizing or denying access to domain resources on a task by task basis.

Method 750 can be implemented by the execution of programming instructions 205 on processor 201 of FIG. 1. However, it is to be reemphasized that variations of the method 750 and system 50 are contemplated. It is also to be understood that the blocks in method 750 need not be performed in the exact sequence shown, and that various blocks can be performed in parallel.

At block 701, processor 201 is configured to receive data from machine 100, such as a account name or other account identifier. The received data can also include a password. Processor 201 is configured to authenticate machine 100 by comparing the received account name and password to accounts stored in non-volatile storage 203. Via the authentication, processor 201 determines privileges granted to machine 100 relative to accessing existing data at machine 300, and/or relative to creating new data for storage at machine 300. Within an account, one or more user identities (referred to herein as “personas” or “users”) may be defined, to enable a more detailed level of authorization (such as allowing a user to view the contents of tasks, or meetings in which they are a participant, but not those for which they do not participate in) for viewing and editing data based on a user identity (“persona”). The benefit of having multiple user identities for example, a “work” identity, and a “home” identity, is that a user identity may be transferred from one account to another, on occasions such as a personnel change within an organization, so that the task lists, and information relating to meetings, projects, and/or processes, can be quickly and easily transferred to another account that might be managed by a different individual person. Because there are multiple user identities within an account, this can be done without also transferring an individual's tasks that relate to another user identity—a user could move all of their “work” tasks to another account, but keep their “personal” tasks.

Such authorization data can relate to a specific task, and can be stored on machine 300 (specifically, in database 306), in association with a user who has ownership responsibility for the specific task (that is, the responsibility for managing the task and permission to update all aspects of the task data). The data can be received at processor 201 via network interface 202, having arrived from machine 100 where the data was received at processor 101 from input device 102 and transmitted via network interface 104. The data for authentication includes the account identifier, and may include an identifier of a requested task. The machine 200 determines if this account (and, if required, also a user identity) should be allowed to receive and update data or specific subsets of data (relating to the requested task, if machine 100 has requested access to an existing task stored at machine 300).

At block 702, processor 201 is configured to receive data from machine 100 defining a task. The data can be received at processor 201 via network interface 202, having arrived from machine 100 where the data was received at processor 101 from input device 102 and transmitted via network interface 104. The data includes a brief description of the task (for example, the string “complete design review”), and task planning information. Task planning information can include proposed start and completion dates and/or times, as well as identifiers of predecessor or follow on tasks (which are existing tasks stored at machine 300), for linking the task to be created to the predecessor or follow on tasks. In addition, the task data can include an identifier of an owner user identifier, indicating which user has ownership responsibility for the task. In some embodiments, the owner user identifier can be automatically selected as the primary user (that is, the primary persona) for an account that was authenticated at block 701. Processor 201 is then configured to automatically tag the newly created task by adding one or more tags to the data. The tags may include a representation of a status (such as whether or not the task has been completed), an indication of the position of the task in a workflow comprising a plurality of tasks, and the like, to assist in the management of the task.

At block 703, processor 201 is configured to optionally receive data from machine 100 to define team members (other additional users) who may participate on the same task. The data can be received at processor 201 via network interface 202, having arrived from machine 100 where the data was received at processor 101 from input device 102 and transmitted via network interface 104. The data includes identifiers of zero or more other users (for example, as a user identifier, a text string, or as another identifier linking to the user), and a role (for example a string, or a link to a pre-defined role, such as “Core Team Member”, or “Electrical Engineer”) for each identified user. The definition of team membership and role identifier allows machine 200 to determine the appropriate default level of access for each user associated with the task, relative to viewing and updating data relating to the task. The performance of block 703 can occur simultaneously with block 702 in some embodiments.

At block 704, processor 201 is configured to receive data from machine 100 defining specific responsibilities for specific users relating to specific tasks, as submitted, via machine 100, by a user with ownership privileges for the task (more specifically, through account 700 as authenticated to be able to perform this action on system 50 at block 701). The performance of block 704 can occur simultaneously with one or both of blocks 702 and 703 in some embodiments. The data can be received at processor 201 via network interface 202, having arrived from machine 100 where the data was received at processor 101 from input device 102 and transmitted via network interface 104. The data includes at least one of the user identifiers listed as a team member via block 703, and a responsibility level (for example, a string, or else a link to a pre-defined level of responsibility, such as “Responsible”, or “Consulted”). The definition of a team member's responsibility level allows the system to determine the appropriate default level of access for the user associated with that team member to view and update data relating to the task, when accessing system 50. Common methodologies for this responsibility identification exist, and implementation of any or all of them is contemplated, including RACI (Responsible, Accountable, Consulted, Informed) matrix, RAM (Responsibility assignment matrix), LCR (linear responsibility chart) describing participation by various responsibility levels in completing tasks.

At block 705, processor 201 is configured to transmit and receive task update data to and from machine 100 to assist the task owner in managing the workflow of the task. The data can be received at processor 201 via interface 202, having arrived from machine 100 (or from multiple machines having similar configurations to that of machine 100) where the data was received at processor 101 from input device 102 and transmitted via network interface 104. The data may also be transmitted from processor 201 via interface 202 to machine 100, where the data is received at processor 101 via interface 104, and then rendered to the output device 103.

At block 706, processor 201 is configured to determine whether an indication has been received that the task is complete. Such an indication can be received, for example, from machine 100 following the receipt of input data at input device 102. In other examples, the indication can be generated automatically by processor 201 based on updates to the task data received at blocks 705, 707, 708 and 709. Such updates can indicate that one or more parts of a task are complete.

At block 707, processor 201 is configured to transmit and receive task update data to and from machine 100 to assist the task owner in performing their own task execution responsibilities for the task. The data can be received at processor 201 via interface 202, having arrived from machine 100 (or from multiple machines having similar configurations to that of machine 100) where the data was received at processor 101 from input device 102 and transmitted via network interface 104. The data may also be transmitted from processor 201 via interface 202 to machine 100, where the data is received at processor 101 via interface 104, and then rendered to the output device 103.

At block 709, processor 201 is configured to transmit and receive task update data to and from machine 100 to assist the task owner in updating the task. The data can be received at processor 201 via interface 202, having arrived from machine 100 (or from multiple machines having similar configurations to that of machine 100) where the data was received at processor 101 from input device 102 and transmitted via network interface 104. The data may also be transmitted from processor 201 via interface 202 to machine 100, where the data is received at processor 101 via interface 104, and then rendered to the output device 103.

At block 710, processor 201 is configured to transmit and receive task update data to and from machine 100 to assist the task owner in closing the task. The data can be received at processor 201 via interface 202, having arrived from machine 100 (or from multiple machines having similar configurations to that of machine 100) where the data was received at processor 101 from input device 102 and transmitted via network interface 104. The data may also be transmitted from processor 201 via interface 202 to machine 100, where the data is received at processor 101 via interface 104, and then rendered to the output device 103.

The task update data for blocks 705, 707, 709, and 710 may include any of the previously recorded information, but may also include personal memos sent from machine 100 (long data streams which may include text and other multi-media data), visible only to the user, and updatable only by the user or public memos sent from machine 100 (long data streams which may include text and other multi-media data) which may be viewed and updated by other team members, depending on their defined roles and responsibilities. The data may also include reminders sent from server 200 to machine 100, for example, to complete tasks (reminders can be sent in the form of emails, SMS communications, or other social media messages), as well as warnings of upcoming deadlines, and the like (which can also be sent as emails, SMS messages and the like). The data may also include notifications that predecessor tasks have been completed, or that a prerequisite event has now been triggered.

Examples of pre-requisite events include the receipt of a document from another user, the upload of an attachment by another user, the complete set of pre-requisite tasks having been completed, the status of the availability of a team member (e.g. returning from vacation), etc. Required pre-requisite events can be received from machine 100 and stored in the task data. Some of the data may also include specific reminders triggered by the task owner (that is, triggered “manually” as a result of a request from machine 100 having authenticated using the account with ownership responsibility), and sent automatically by server 200, such as reminders that tasks should be updated before a specific date, or a specific event such as a meeting. The data sent from server 200 can be the completion status for a task, and warnings that due dates are upcoming or past, such as “overdue” tasks, when the target completion date has passed, or “Should have started already” tasks, when the target start date has passed. The data sent from server 200 may also include history information—such as the name of the user and the date when a status changed, or the addition of a team member to a task, or the change in role or responsibility for a team member relating to a task.

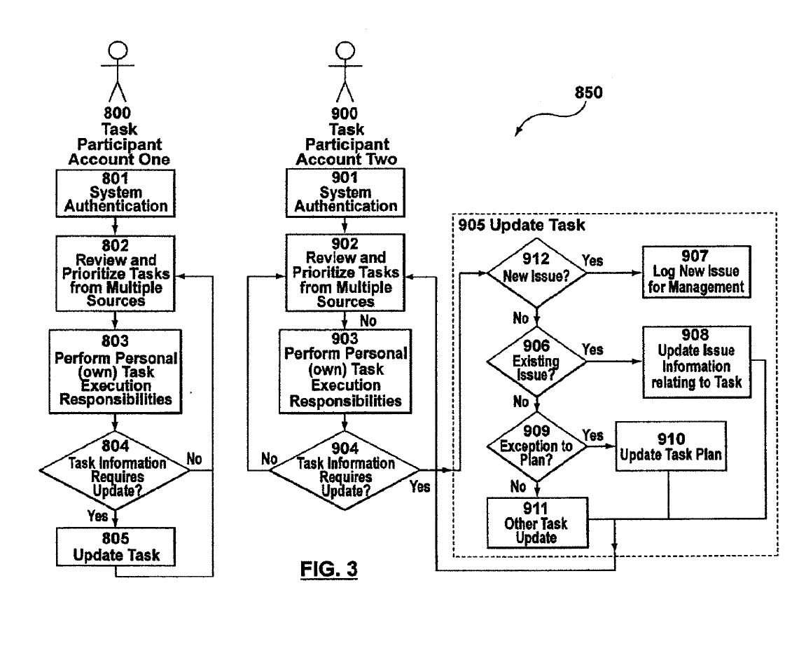

For example, the task owner can then use his/her own client machine 100, via account 700, to update task information 709, which is then accessible to all task team members over the network at their own computers (multiple instances of machine 100). The task owner may also have their own personal execution responsibilities 707 for elements of the task, which can also be updated at 709, via his/her account 700, as described in greater detail below with reference to FIG. 3).

Expanding on the discussion above, at block 709, processor 201 is configured to receive data from machine 100 for updating a task. The data can be received at processor 201 via network interface 202, having arrived from machine 100 where the data was received at processor 101 from input device 102, or from volatile storage 106, or from non-volatile storage 105. Processor 201 is configured to transmit the data to machine 300, which can record the data to volatile storage 303 and/or non-volatile storage 302. The update data may include changes in status, target or actual dates, team member role and responsibilities, and other information relevant to the task. At block 709, processor 201 can also be configured to transmit data to one or more machines such as machine 100 to report on updated task information, for automatic distribution to all team members of a particular task. The data can be received at the one or more machines 100 via respective network interfaces 104, having arrived from machine 200 where the data was accessed from machine 300. The data may then be displayed on machine 100 via the output device 103, or stored in non-volatile storage 105, or in volatile storage 106 for later display.

Also expanding on the discussion above, at block 710, processor 201 is configured to receive data from machine 100 for closing a task. The data can be received at processor 201 via network interface 202, having arrived from machine 100 where the data was received at processor 101 from input device 102 and transmitted via network interface 104. The data includes an indication of the status (for example, the string ‘Closed: Complete’, or a link to a pre-defined status), and may also include an actual completion date and time.

Referring now to FIG. 3, a pair of additional instances 850 of the method according to FIG. 2 are shown, for additional task participants (i.e. identified as team members of the task by the task owner at block 704), and represented by respective accounts 800 and 900, to manage respective responsibilities relating to the single task of FIG. 2, and contribute to the workflow. Task participants are specific individuals responsible for doing work required for the completion of the shared task. Method 850 can be implemented as programming instructions 205 executable on processor 201 of FIG. 1. However, it is to be reemphasized that variations of the method instances 850 and system 50 are contemplated. It is also to be understood that the blocks in method instances 850 need not be performed in the exact sequence shown, and that various blocks can be performed in parallel. Moreover, it will be appreciated that additional instances 850 may be created for additional participants.

Blocks 801 and 901 are substantially as described above in connection with block 701 of FIG. 2. At blocks 802 and 902, processor 201 is configured to receive from and/or transmit to one or more machine(s) 100 to allow each individual user to review, prioritize, and update tasks via their respective accounts 800 and 900 on the system 50, according to their own personal schedules and availability across many different projects, or client customers. The data can be received at processor 101 via network interface 104, having arrived from machine 200 where the data was obtained from machine 300, and subsequently transferred via network interface 202. This data may then be displayed immediately at output device 103, or be stored in non-volatile storage 105, or volatile storage 106 for later display. The data can also be received at processor 201 via network interface 202, when arriving from machine 100 where the data was received at processor 101 from input device, and transmitted via network interface 104, when a user is adding information to system 50 about a task. Such tasks may be individual tasks, or may come from various sources of tasks which require shared responsibility, including meetings, projects, and business or operational processes. Block 803 and 903 represent individual work that is to be done by the individuals via their accounts 800 and 900 (as discussed above in connection with block 707), respectively, which may be completely external to the system 50, but generate data that can then be entered at machine 100, for transmission to server 200.

At blocks 804 and 904, a determination is made as to whether the data associated with a task at servers 200 and 300 needs to be updated. At block 805 and 905, processor 201 is configured to receive data from machine 100 updating the task. The data can be received at processor 201 via network interface 202, having arrived from machine 100 where the data was received at processor 101 from input device 102, or from volatile storage 106, or from non-volatile storage 105. Processor 201 is configured to transmit the data to machine 300, which can record the data to volatile storage 303 and/or non-volatile storage 302. The update data may include information relevant to the task, including any task-related data discussed above. At block 805 and 905, processor 201 can also be configured to transmit data to one, or a multitude of machine(s) 100 to report on updated task information, for automatic distribution to all participants of a particular task. The data can be received at one or more machine(s) 100 via network interface 104, having arrived from machine 200 where the data was accessed from machine 300. The data may then be displayed on machine 100 via the output device 103, or stored in non-volatile storage 105, or in volatile storage 106 for later display. Upon completing such work, the task may optionally be updated (Block 905), with contributions individually identified by specific participants.

At block 905, processor 201 is configured to receive from and/or transmit to one or more machine(s) 100 to allow each individual user to record and update issues, risks, and other additional information relating to tasks, on system 50. The data can be received at processor 101 via network interface 104, having arrived from machine 200 where the data was obtained from machine 300, and subsequently transferred via network interface 202. This data may then be displayed immediately at output device 103, or be stored in non-volatile storage 105, or volatile storage 106 for later display. The data can also be received at processor 201 via network interface 202, when arriving from machine 100 where the data was received at processor 101 from input device 102 and/or volatile storage 106 and/or non-volatile storage 105, and transmitted via network interface 104, when a user is adding information to system 50 about a task. The data may include “Issues” which may denote problems with assumptions (including pre-requisites), and risks (which require management), thus making these issues visible and available for management to all task participants, including the task owner represented by account 700.

At block 907, if a new issue is to be recorded (a “yes” determination at block 912) the data relating to logging a new issue may include the identifier for the user (persona) responsible for reporting on the issue, a check-in date, and one or more memos (long text strings) that may describe the issue, a priority indication, a severity indication, in addition to a set of user identifiers for people assigned to help resolve the issue.

At block 908, in addition to the data described for block 907, the data may additionally be augmented by additional memos that include and describe decisions, and/or memos that generally provide additional detail about the progress of the resolution of an existing issue (following a “yes” determination at block 906), as well as target and actual resolution dates. The system also takes input from task participants to log exceptions (following a “yes” determination at block 909) to plan, including schedule (potential and real delays, time estimate corrections), cost (for example budgetary over-runs, or incorrect resource estimates), or performance (failure to meet requirements or measurement constraints, relating to the task), allowing task participants and owners to update the execution plan for the task (Block 910).

At Block 911 processor 201 is configured to receive data from machine 100 providing additional task update information. Processor 201 is configured to receive data from machine 100 for updating a task. The data can be received at processor 201 via network interface 202, having arrived from machine 100 where the data was received at processor 101 from input device 102, or from volatile storage 106, or from non-volatile storage 105. Processor 201 is configured to transmit the data to machine 300, which can record the data to volatile storage 303 and/or non-volatile storage 302. The additional task update information data may include the tracking of schedule, performance, and budget relating to the task, as well as individual comments, and/or the attachment of other binary files, which can be made visible to other task participants, enabling improved communication about task execution.

In addition to enabling the functionality specifically described above, method 850 can also be modified to provide for automatic recording of individual effort (time) relating to shared tasks, based on the frequency of interaction of individual task participants (for example the participants represented by accounts 800, 900) with the system, and time delays between successive entries of information to the system using input device 102, via their own instances of machine 100. Data for block 911 may also include schedule remarks by individual task participants, which may impact the overall schedule of the task. Data for block 911 also may include the ability for task participants to confirm actual schedule and effort estimates of their work on tasks that have been calculated automatically by the system. Data for block 911 may also include cost or performance warnings or remarks.

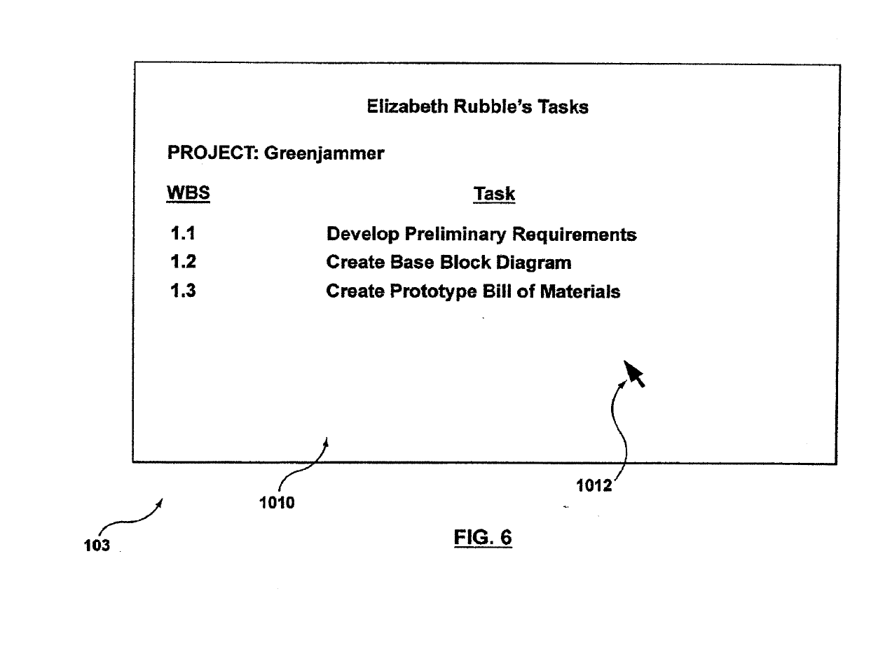

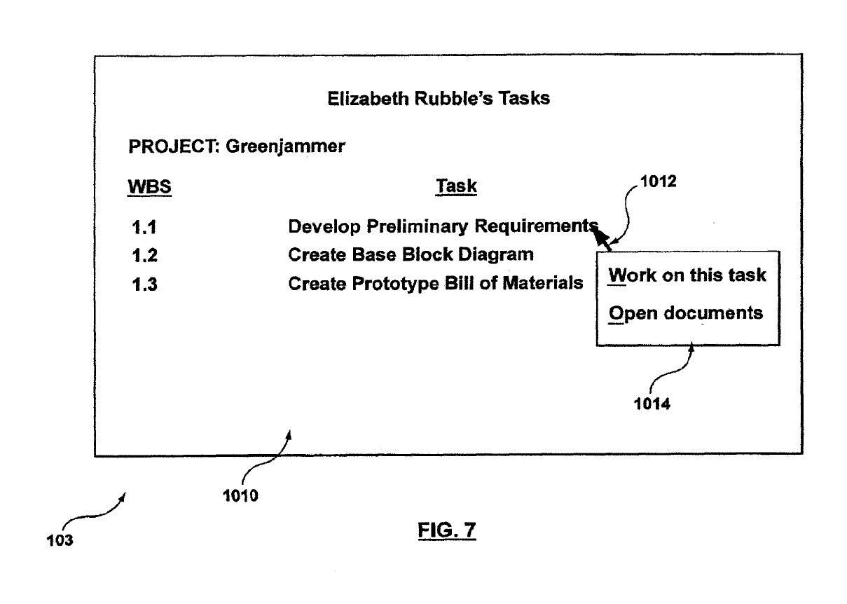

Block 911 also contemplates the inclusion of time tracking, which will be discussed further below in relation to FIG. 6 and FIG. 7.

Task participants' usage of the system is also contemplated via use of additional machines 100 (clients) which may not continuously be connected to the network. In this case, the machine 100 records task information by the individuals, and when the machine is later connected to the network, the system synchronizes the shared task information with the server machine 200.

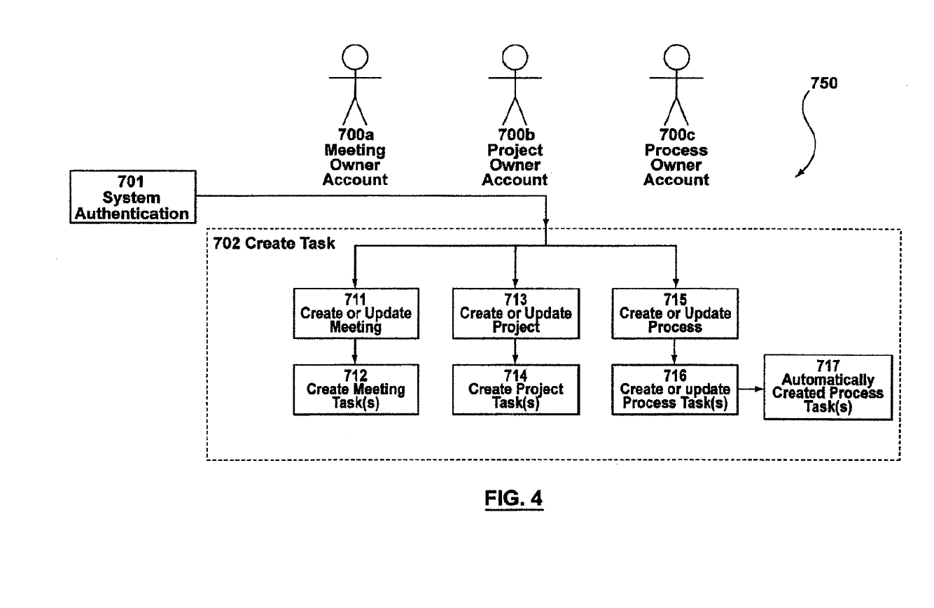

FIG. 4 shows details of the create task block 702. Task owners may be meeting owners, project owners, and/or process owners represented by respective accounts 700a, 700b and 700c and selected or implied user identities (that is, user identities explicitly selected by machine 100, or user identities deduced by processor 201 based on task data or, for example, an identifier of machine 100 which may have been used in connection with a particular identity in the past). For example, a meeting owner may be a person who hosts a meeting of various people, and wishes to record tasks with individual and/or shared responsibility using system 50. In this context, the task owner is a meeting owner represented by account 700a and one of its user identities, and in this case, a task source may be a meeting created at block 711. Thus, at block 711, processor 201 is configured to receive and/or transmit data from machine 100 creating or updating the meeting. The data can be received at processor 201 via network interface 202, having arrived from machine 100 where the data was received at processor 101 from input device 102 and transmitted via network interface 104. At block 712, the meeting owner can potentially create multiple tasks relating to the same group of individuals (the meeting participants), at the same time, by entering information in input device 102, and transmitting this information via network interface 104 to processor 201, which can then add or update the data in machine 300.

Account 700b represents the account and selected or implied user identity of a project owner an individual who may create and update project information using system 50. In this context, the task owner is the project owner represented by account 700b, and in this case, a task source may be a project created at block 713. Block 714 represents the interaction of account 700b with the system which results in the creation of one or more individual and/or shared responsibility tasks, from within a group of individuals which may vary over time, with assignments changing responsibility over time (via the project owner interaction with the system within block 709 via account 700b. Thus, at block 713, processor 201 is configured to receive and/or transmit data from machine 100 creating or updating the project. The data can be received at processor 201 via network interface 202, having arrived from machine 100 where the data was received at processor 101 from input device 102 and transmitted via network interface 104. At block 714, the project owner can potentially create multiple tasks relating to the same group of individuals (the project participants).

Account 700c represents the account and selected or implied user identity of a process owner, an individual who may create and update recurring process information, using system 50. In this context, the task owner is a process owner represented by account 700c, and in this case, a task source may be a process created at step 715. Thus, at block 715, processor 201 is configured to receive and/or transmit data from machine 100 creating or updating the process. The data can be received at processor 201 via network interface 202, having arrived from machine 100 where the data was received at processor 101 from input device 102 and transmitted via network interface 104. Block 716 represents the interaction of account 700c with the system which results in the creation of one or more individual and/or shared responsibility tasks, from within a group of individuals which may vary over time. Although the responsibilities are assigned to a role, these role assignments may also change over time (for example from account 800 to 900). In this case, the process owner may create or update process tasks, and the system 50 will automatically generate individual and/or shared responsibility tasks (block 717), as the process description from block 715 requires. At block 716, the project owner can potentially create multiple tasks relating to the same group of individuals (the process participants). To further describe block 717, for example, a weekly process may be described in block 715, with multiple tasks in response to which automatic tasks are created on a weekly basis for individual participants and groups (e.g. represented by accounts 800 and 900, and others), based on the tasks described in block 716.

Since tasks may come from a variety of sources as described in FIG. 4, individual participants, by using blocks 802, 902, or other instances of the same interaction, are able to prioritize their tasks, which may come from a variety of sources, including but not limited to meetings (block 711), projects (block 713), and processes (block 715). For example, individuals may create their own tasks, for which they are the owner, and can assign other individuals to share responsibility for these tasks as well.

Block 802 and 902 include a mechanism whereby server 200 may recommend improved priority for tasks, based on other entered relevant information such as relative priority of various meetings, relative to projects, relative to processes, etc. Such a recommendation can be provided in response to a request from machine 100, via selection of a user interface element presented on output device 103 (such as an element reading “help me prioritize or reprioritize”).

Further, based on tracking of interaction with the system via the method instances 850, server 200 can further report on time allocations to individual meetings, projects, and processes, as well as customized aggregates of each. Server 200 can also calculate estimated time allocations based on interaction with machine 100, or multiple machines 100, with logged in accounts, based on activity of interaction via the input device 102. Based on this information, server 200 can also suggest modifications to priority of tasks for individuals based on true time usage. System 50 can then also automatically collect and aggregate total time allocated by multiple team members towards any shared task, as well as aggregating totals for individual meetings, processes and projects.

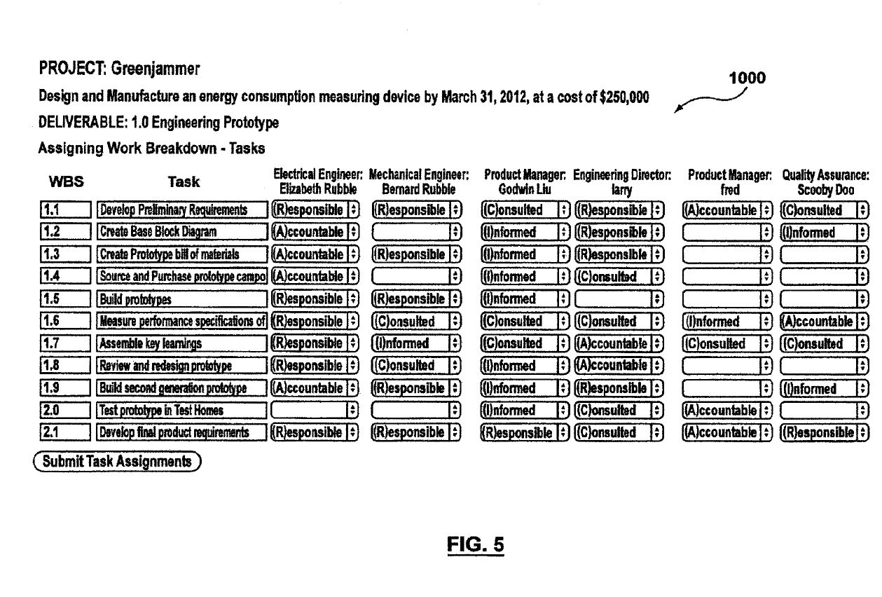

It will be appreciated that interaction between task owners, participants and the system 50 for implementing the methods 750, 850, etc., may be effected using input devices 102 and output devices 103 of various instances of machine 100, for implementing Graphical User Interfaces (GUIs). For example, FIG. 5 shows a GUI 1000 generated by the system 50 as a result of block 704, wherein task responsibility is assigned among a plurality of participants. A person of skill in the art will appreciate that different GUIs may be created for various blocks in the methods 750, 850, etc. of the exemplary embodiment.

The present specification also contemplates the inclusion of advanced time tracking methods implemented in system 50. For example, in FIG. 6 output device 103 is shown in the form of a display, and is referred to hereafter as display 103. Display 103 is shown as displaying a portion of the contents of a process owner account 700c. Display 103 as shown thus comprises a project identifier (“Greenjammer”), an Account Holder (“Elizabeth Rubble”) and a list of tasks (“Tasks” column), which are all indexed (“WBS” (Work Breakdown Structure—a project management term which refers to the enumerated division of work into tasks) column). Display 103 is also shown as displaying a pointer 1012 which can be moved using a pointing input device, such as a mouse, trackpad, touchpad, or touch screen over various elements that are being displayed. Referring now to FIG. 7, pointer 1012 is shown as having been placed over one of the three example tasks listed on display 103. Machine 100 is thus configured to generate a popup menu 1014 that includes a plurality of options, including the option to select “Work on this task”. The wording is not specific and only an example. (Other options can also be displayed, such as “Open documents” referring to opening electronic documents associated with the selected task. Other options will occur to those skilled in the art.) When the “Work on this task” option is selected, a timer can automatically begin recording an elapsed period of time in association with the selected task and the current process account 700c. Also of note is that the timer can be configured to automatically terminate after a predetermined period of inactivity on machine 100. For example, if machine 100 is not used for five minutes, then machine 100 can be configured to assume that work on that task is still occurring and to therefore continue measuring elapsed time with the timer associated with that selected task and account 700c. However, if thirty minutes have passed with no interaction on client machine 100, then the time tracking can determine an estimated amount of time. (e.g. 15 minutes of the entire 30 minutes or some other percentage of the threshold time) and record that time against the timer. That estimated time can be flagged as such for manual confirmation or override, if desired. A third threshold level of time (E.g. 2 hours) can be set that causes the time tracking to be ignored altogether, even overriding or deleting the estimated time recorded at the second (i.e. 30 minute) inactivity interval.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A system for improving team productivity relating to task execution comprising:
at least one client including input and output devices;
at least one server connected to said at least one client via a network;
computer readable media including program instructions which when executed by a processor in at least one of said client or server causes the processor to implement a method for management of a workflow for a task owner account, wherein the workflow relates to a single task with shared responsibility and shared work within a team of participants each having a respective accounts.

2. The system of claim 1, wherein said task owner account is associated with a specific individual responsible for managing the workflow and completion of the task by said team.

3. The system of claim 1, wherein the server comprises a distributed computing system.

4. A method for improving team productivity relating to task execution comprising:
creating a task owner account from which at least one single task is created with shared responsibility and shared work within a team of participants each having respective accounts;
assigning participant responsibilities within said team for said shared work; and
managing task execution via said task owner account.

5. The method of claim 3, wherein managing said task execution further includes assessing whether all parts of said task have been completed and if so closing said task, and if not performing individual task execution and assessing whether task information requires updating and if so updating said task information.

6. The method of claim 4, wherein updating said task information includes recording of issues which may denote problems with assumptions, and risks, and making said issues visible and available for management to all task participants.

7. The method of claim 5, further including receiving input from task participants to log exceptions to plan and in response allowing task participants to update execution of a plan for said task.

8. The method of claim 6, wherein said exceptions include at least one of exceptions to schedule, cost, or performance.

9. A method for improving collaborative work productivity comprising:
recording names and descriptions of tasks;
recording proposed start and completion dates of said tasks;
recording individual responsibilities of multiple participants relating to a single task;
making task information available to all participants with responsibilities relating to the same task via a networked device;
enabling workflow control for individual participants with task ownership responsibility; and
outputting automatically generated reports tracking progress of work from multiple participants relating to said single task.

10. The method of claim 8 further comprising recording cost information about a task, including one or more of labour cost (human effort) and other budget expenditures relating to the task.

11. The method of claim 8, further comprising at least one of:
recording individual time estimates for a shared task;
recording individual scheduling estimates for a shared task;
recording actual effort and schedule information for shared tasks automatically; and
asynchronous data entry.

12. The method of claim 8, further comprising at least one of:
recording and managing individual personal priorities for tasks that are collaboratively executed by multiple people; and
automatically suggesting modifications to priority of tasks for individuals, when process and/or project and/or meeting priorities are adjusted by other people.

13. The method of claim 8, further comprising at least one of:
automatically recording time allocated to tasks based on interaction with the system;
automatically suggesting modifications to priority of tasks for individuals based on actual time usage;
automatic collection and aggregation of total time allocated and used by multiple team members for a collaborative task; and
automatic collection and aggregation of total time allocated and used in multiple tasks relating to a single meeting, process, or project.
